(19) United States
(12) Patent Application Publication
(10) Pub. No.: US 2008/0142375 A1
(43) Pub. Date: Jun. 19, 2008

(54) ELECTROLYTE FORMULATION FOR ELECTROCHEMICAL MECHANICAL PLANARIZATION

(76) Inventors: Francois Doniat, Wilmington, DE (US); Matthew L. Fisher, Allen, TX (US); Alan D. Zdunek, Chicago, IL (US); Alexandro A. Barajas, Montgomery, IL (US); Ian Suni, Potsdam, NY (US); Xiangfeng Chu, Potsdam, NY (US); Abhinav Tripathi, Potsdam, NY (US); Yuzhuo Li, Norwood, NY (US)

Correspondence Address: AIR LIQUIDE;Intellectual Property, 2700 POST OAK BOULEVARD, SUITE 1800, HOUSTON, TX, 77056, US

(21) Appl. No.: 11/864,254

(22) Filed: Sep. 28, 2007

Related U.S. Application Data
(60) Provisional application No. 60/874,592, filed on Dec. 13, 2006.

(51) Int. Cl. B23H 3/00

(52) U.S. Cl. 205/662; 205/682

(57) ABSTRACT

Compositions and methods suitable for the electrochemical mechanical planarization of a conductive material layer on a semiconductor workpiece. Compositions contain a phosphonic acid based electrolyte, a corrosion inhibitor, a chelating agent, a pH adjusting agent, and a solvent as the remainder.

### CROSS REFERENCE TO RELATED APPLICATIONS

The present application claims the benefit of U.S. Provisional Application Ser. No. 60/874,592, filed Dec. 13, 2006, herein incorporated by reference in its entirety for all purposes.

### BACKGROUND

One common step in the production of integrated circuits for use in electronic equipment includes the deposition of multiple thin film layers on the surface of a substrate. By varying the materials deposited between conducting, semiconducting, and dielectric type materials, and by selectively depositing and removing at least part of the layers, the various features (transistors, capacitors, interconnecting wires, etc) of an integrated circuit are created. Commonly known methods for depositing these films include chemical vapor deposition (CVD), atomic layer deposition (ALD), physical vapor deposition (PVD), plasma-enhanced chemical vapor deposition (PECVD), and electrochemical plating (ECP).

The reliable production of sub-micron and smaller features is crucial for manufacturing of next generation “very large scale integration” (VLSI) and “ultra large scale integration” (ULSI) semiconductor devices. As these manufacturing methods progress, the required dimensions for interconnects continue to shrink, thereby placing additional demands and constraints on the VLSI and ULSI manufacturing processes. Reliable creation of these interconnects is crucial for the continued success of VLSI and ULSI manufacturing techniques.

The ultra-fine wires used as interconnects are normally created by creating small trenches on the surface of semiconductor wafer. This trench is then filled first with a barrier material, and then with a metallic material such as copper, to create a metallic interconnect layer. Normally, the copper deposited in the trench, typically through a copper electroplating step or a damascene process, is “over plated” such that copper overfills the trench and is plated in areas on the substrate surface which are not desirable. Over plating can cause hills or bumps on the metallic interconnect layer, which may prohibit the building of multiple layers above. Therefore, it is necessary to polish or planarize the metallic interconnect layer in order to remove the over plating and allow for additional layers to be added.

One method of polishing or planarizing the metallic layer is Chemical Mechanical Polishing (CMP). CMP methods generally include dressing a large polishing pad with an ultra fine slurry solution, and then pressing, with a reasonable down-force, the silicon wafer onto the polishing pad. Either the pad, the wafer or both are then rotated in a circular fashion to planarize the surface of the wafer. The wafer surface is polished by both the mechanical action of the slurry and by the chemical activity created between the slurry and the material to be removed. However, as the materials used in the manufacture of semiconductor materials continue to become increasingly delicate (for instance, low-k dielectric materials), conventional CMP methods may impart too much force to the surface of the wafer, thereby causing damage to the delicate materials surrounding the material intended to be removed. Hence, conventional CMP methods are approaching their practical limitations, especially with respect to low-k materials and copper metallic layers.

One technique which has been developed in response to the limitations of the CMP process is known as electrochemical mechanical planarization (ECMP). ECMP techniques entail removing the conductive material from the substrate through an electrochemical dissolution, while concurrently submitting the substrate to a mechanical polishing step. One electrolyte polishing solution is provided, which facilitates both the chemical dissolution and the mechanical polishing. The electrochemical dissolution is typically created by applying an electrical bias between a cathode and the substrate surface, thereby allowing the conductive materials to be removed into the electrolyte solution. At about the same time, the substrate is subjected to a mechanical polishing step which uses considerably less force than that used in conventional CMP polishing steps, thereby reducing the damage to the surrounding layers on the wafer surface.

Electrochemical mechanical planarization requires electrolytes optimized to allow efficient removal of the metallic layer through both the electrochemical dissolution and the mechanical modes. As a result, there is a need for improved electrolyte solutions for use in electrochemical mechanical planarization methods.

### SUMMARY

Novel formulations and methods for the electrochemical mechanical planarization of a semiconductor work-piece are described herein. The disclosed methods and formulations utilize phosphonic acid based electrolytes to promote the planarization or polishing of one or more metallic layers on a semiconductor wafer.

In an embodiment, an electrolyte polishing composition comprises a phosphonic based electrolyte in an amount between about 1%, and about 20%, by weight; a corrosion inhibitor in an amount between about 0.01% and about 1.0%, by weight; a chelating agent in an amount between about 0.1% and about 10%, by weight; a pH adjusting agent in an amount between about 0.1% and about 35%, by weight; and a solvent as the remainder.

In another embodiment, a method for the electrochemical mechanical polishing of a metal layer in a semiconductor work-piece comprises providing a work-piece having at least one conductive material layer disposed on the its surface, contacting the surface of the work-piece with a polishing solution, and removing part of the conductive material layer through an electrochemical mechanical polishing step. In this embodiment, the polishing solution comprises a phosphonic based electrolyte in an amount between about 1%, and about 20%, by weight; a corrosion inhibitor in an amount between about 0.01% and about 1.0%, by weight; a chelating agent in an amount between about 0.1% and about 10%, by weight; a pH adjusting agent in an amount between about 0.1% and about 35%, by weight; and a solvent as the remainder.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed herein may be readily utilized as a basis for modifying or designing other structures for carrying out the same purposes of the present invention. It should also be realized by those skilled in the art that such equivalent constructions do not depart from the scope of the invention as set forth in the appended claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates graphical results of planarization results for one embodiment according to the current invention, of an electrolyte composition;

FIG. 2 illustrates graphical results of planarization results for second embodiment according to the current invention, of an electrolyte composition;

FIG. 3 illustrates graphical results of planarization results for a third embodiment according to the current invention, of an electrolyte composition;

FIG. 4 illustrates graphical results of planarization results for a fourth embodiment according to the current invention, of an electrolyte composition;

FIG. 5 illustrates graphical results of planarization results for a fifth embodiment according to the current invention, of an electrolyte composition;

FIG. 6 illustrates graphical results of planarization results for a sixth embodiment according to the current invention, of an electrolyte composition; and

FIG. 7 illustrates graphical results of planarization results for a sixth embodiment according to the current invention, of an electrolyte composition.

### DESCRIPTION OF PREFERRED EMBODIMENTS

Generally, embodiments of an electrolyte polishing composition for the electrochemical mechanical planarization of a metallic layer on a semiconductor work-piece comprise a phosphonic acid, a corrosion inhibitor, a chelating agent, and a pH adjusting agent. The particular formulation and combination of these polishing compositions can vary.

Phosphonic acids are generally compounds with the formula:

RP(O)(OH)₂ (I)

Some examples of commonly known phosphonic acids include, without limitation, HEDP (1-hydroxyethylidene diphosphonic acid), MDP (methylene diphosphonic acid), VDPA (vinylidene-1,1-diphosphonic acid), SEDP (2-sulfanatoethylidene-1,1-biphosphonic acid), PBTC (phosphonobutane-tricarboxylic acid), ATMP (1,1-di-phosphonic acid), DTPMP (diethylenetriamine-penta(methylene phosphonic acid)), EDTMP (Ethylendiamine-tetra(methylene phosphonic acid)), HEMPA (Hydroxyethylamino-di(methylene phosphonic acid)), and HDTMP (Hexamethylenediamine-tetra(methylene phosphonic) acid).

In some preferred embodiments of the current invention, the phosphonic acid is either HEDP (1-hydroxyethylidene diphosphonic acid), MDP (methylene diphosphonic acid), VDPA (vinylidene-1,1-diphosphonic acid), SEDP (2-sulfanatoethylidene-1,1-biphosphonic acid), PBTC (phosphonobutane-tricarboxylic acid), or a mixture of two or more of these.

Corrosion inhibitors typically help to protect the metallic layer from undergoing corrosion. Some examples of commonly known corrosion inhibitors include, without limitation, ascorbic acid, benzotriazole, benzimidazol, caffeic acid, cinnamic acid, cysteine, glucose, imidazole, mercaptothiazoline, mercaptoethanol, mercaptopropionic acid, mercaptobenzothiazole, mercaptomethylimidazole, 5-phenyl 1H-tetrazole, tannic acid, thioglycerol, thiosalicylic acid, triazole, vanillin, vanillic acid, tolytriazole, nitrobenzimidazol, members from the azole family and their derivatives, and members of the thiazole family and their derivatives.

In some preferred embodiments of the current invention, the corrosion inhibitor is either benzotriazole, 5-phenyl 1H-tetrazole, benzimidazol, or a mixture of two or more of these.

Chelating agents typically help prevent re-deposition of removed metal onto the semiconductor work-piece by complexing the metal in the polishing solution. Some examples of commonly known chelating agents include, without limitation, ammonium citrate dibasic, ammonium citrate tribasic, ammonium oxalate, aspartic acid, benzoic acid, citric acid, cysteine, diethylenetriamine, ethylenediamine, glycine, gluconic acid, glutamic acid, histidine, hydroxylamine, isopropanolamine, isopropylhydroxylamine, maleic acid, oxalic acid, salicylic acid, or tartaric acid.

In some preferred embodiments the chelating agent is either ethylenediamine, diethylenetriamine, ammonium citrate tribasic, ammonium citrate dibasic, glycine, oxalic acid, or a mixture of two or more of these.

In some preferred embodiments the pH adjusting agent is either potassium hydroxide, trimethylammonium hydroxide, ammonium hydroxide, or a mixture of two or more of these. In certain embodiments the pH of the composition is between about 1 and 10, preferably between about 3 and 8.

In some preferred embodiments of the electrolyte polishing composition, the relative proportion of the components may vary. For instance, the composition may contain between about 5% and about 15%, by weight, of the phosphonic acid based electrolyte. The composition may also contain between about 0.5% and about 6%, by weight, of the chelating agent.

In some embodiments, the electrolyte composition may also include inert abrasive particles in an amount between about 0.1% and about 10% by weight. These particles are suitable to aid in the mechanical polishing portion of the electrochemical mechanical polishing process. Preferred inert particles are colloidal silica, alumina, or ceria particles, all of which are less than about 1 micron in size.

In some preferred embodiments, the composition may also contain a surface finishing component in an amount between about 0.1% and about 2% by weight. Some preferred surface finishing components include propanol, octyl phenol ethoxylate (which is commonly known as “TRITON®-X 100”, and is available from Union Carbide),oxalic acid, alcohols such as isopropyl alcohol, or mixtures of two or more of these.

In some preferred embodiments, the composition may also contain about 0.1% to about 2%, by weight, of a surfactant, such as sodium dodecylbenzene, sodium dodecylbenzene sulfonate, dodecyl trimethyl ammonium bromide, other sulfonated compounds such as ammonium disulfonate, ammonium trisulfonate, or ammonium nitrilo sulfonated compounds.

Certain embodiments of the present invention also provide methods for the electrochemical mechanical polishing of a metal layer in a semiconductor manufacturing process.

Typically, electrochemical mechanical polishing enables the removal of at least a portion of a conductive material layer from a semiconductor work-piece by applying an electrolyte containing polishing solution to the conductive material layer. Part of the conductive material is then removed by combining an electrical anodic potential, or current, created between the conductive layer and the polishing solution, with a mechanical cyclical rubbing force created by a polishing implement, such as a polishing pad, passivation of the conductive material layer normally occurs through the contact with the polishing solution. The passivation is removed at the active layer by the rubbing force, while the lower parts of the conductive layer remain passivated. A measure of the effectiveness of an electrolyte polishing solution can be obtained by examining the differences in current between the active layer and the passivated lower layer of the conductive material.

Generally for ECMP methods, the anodic potential applied may range between about 0 and 6V, and the anodic current may range between about 0 and 50 mA/cm². The rubbing force exerted by the polishing implement may range between about 0 and 2 psi.

The foregoing description is only meant to be illustrative, not exhaustive, of various possible embodiments according to the current invention. A person of ordinary skill in the art would recognize other equivalent constructions which would not depart from the spirit and scope of the current invention, as set forth in the appended claims.

### EXAMPLES

The following non-limiting examples are provided to further illustrate embodiments of the invention. However, the examples are not intended to be all inclusive and are not intended to limit the scope of the inventions described herein.

One method known to determine the suitability of an electrolyte polishing composition for use in electrochemical mechanical planarization is to view its dissolution properties as plotted on a linear sweep voltammetric curve.

These curves represent a method estimating results of the polishing of a passivated layer. A rubbing curve is displayed which represents the part of the conductive layer which is removed due to the rubbing force, and the no rubbing curve represents the part of the conductive layer which remains stable. The difference in the current values between the two curves, at a given potential, is an indication of the step high reduction speed occurring on the conductive layer. The higher this relative difference, the greater the planarization of the conductive layer.

Potential-current curves were generated for various embodiments of the current invention with a potentiostat in a three electrode system. The working electrode was a copper sample, the counter electrode was made from platinum and the reference electrode was either a calomel electrode or silver/silver chloride electrode. Potentials were measured in small increments from the open circuit potential to about 3.5 volts.

The three electrodes were immersed in an electrolyte solution (Compositions A-E described below) and the copper sample was either rubbed or not. The rubbing was performed by rotating the copper sample in contact with an ECMP type polishing pad. Thus for each Composition, a rubbing curve (where the copper sample was rubbed on the polishing pad) and a no rubbing curve (where the copper sample was not rubbed) was produced. The difference in height between these curves, as described above, is an estimation of the effectiveness electrolyte composition.

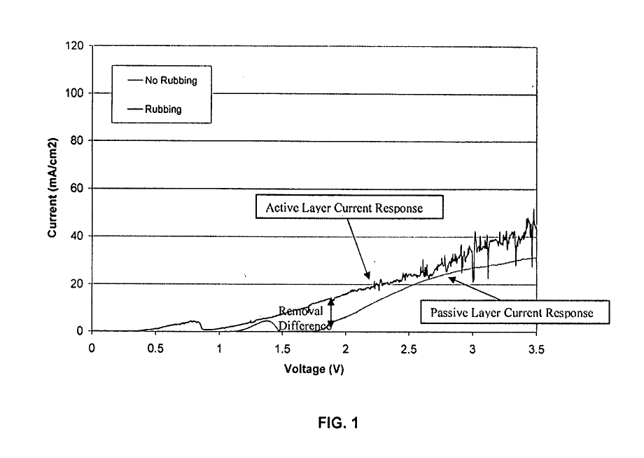

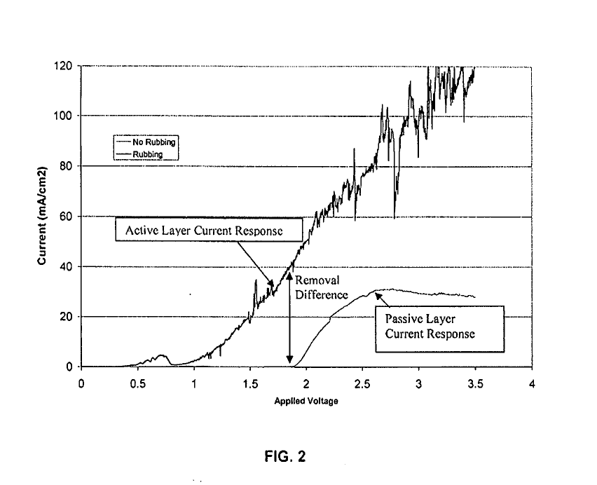

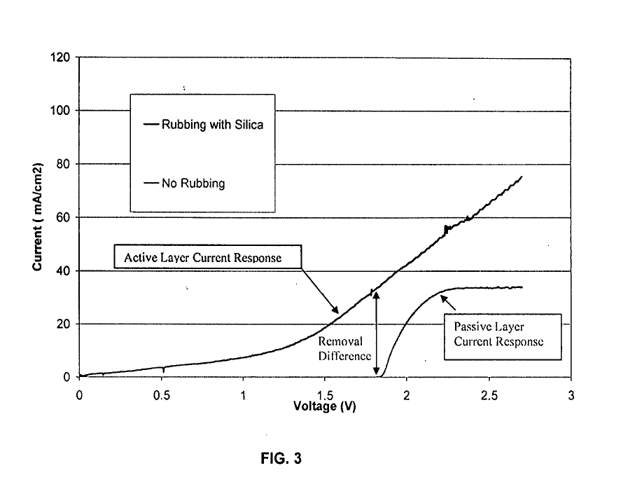

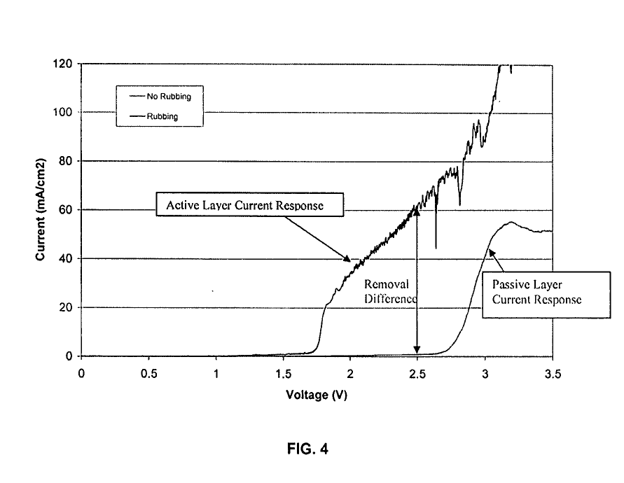

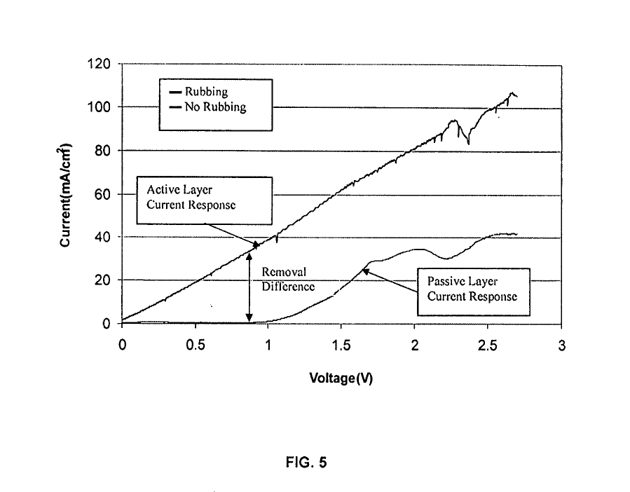

Such voltammetric curves were generated for the various embodiments according to the current invention of polishing compositions described below.

| | |
|---|---|
| Composition A as shown in FIG. 1: | |
| HEDP (1-hydroxyethylidene diphosphonic acid) | 6 wt % |
| Benzotriazole | 0.6 wt % |
| Ethylenediamine | 2.0 wt % |
| Water | Balance |
| pH | 5-6 |
| Composition B as shown in FIG. 2: | |
| HEDP (1-hydroxyethylidene diphosphonic acid) | 6 wt % |
| Benzotriazole | 0.6 wt % |
| Tribasic Ammonium Citrate | 1.0 wt % |
| Potassium Hydroxide | added to adjust pH |
| | to about 6.0 |
| Water | Balance |
| Composition C as shown in FIG. 3: | |
| HEDP (1-hydroxyethylidene diphosphonic acid) | 6 wt % |
| Benzotriazole | 0.6 wt % |
| Tribasic Ammonium Citrate | 1.0 wt % |
| Potassium Hydroxide | added to adjust pH |
| | to about 6.0 |
| Colloidal Silica | 1.5 wt % |
| Water | Balance |
| Composition D as shown in FIG. 4: | |
| HEDP (1-hydroxyethylidene diphosphonic acid) | 6 wt % |
| Benzotriazole | 0.6 wt % |
| Tribasic Ammonium Citrate | 1.0 wt % |
| Potassium Hydroxide | added to adjust pH |
| | to about 8.0 |
| Water | Balance |
| Composition E as shown in FIG. 5: | |
| HEDP (1-hydroxyethylidene diphosphonic acid) | 6 wt % |
| 5 Phenyl 1H-tetrazole | 0.015 wt % |
| Oxalic Acid (dehydrate) | 0.82 wt % |
| Potassium Hydroxide | added to adjust pH |
| | to about 3.0 |
| Water | Balance |

Two polishing compositions according to embodiments of the current invention were prepared and tested on patterned wafers to determine the compositions ability to remove the metallic over plate. The results of these tests were then graphed as a function of the reduction of the overall step height.

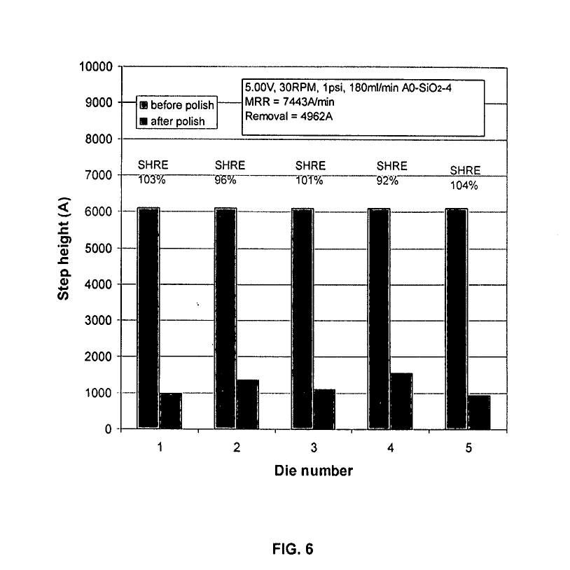

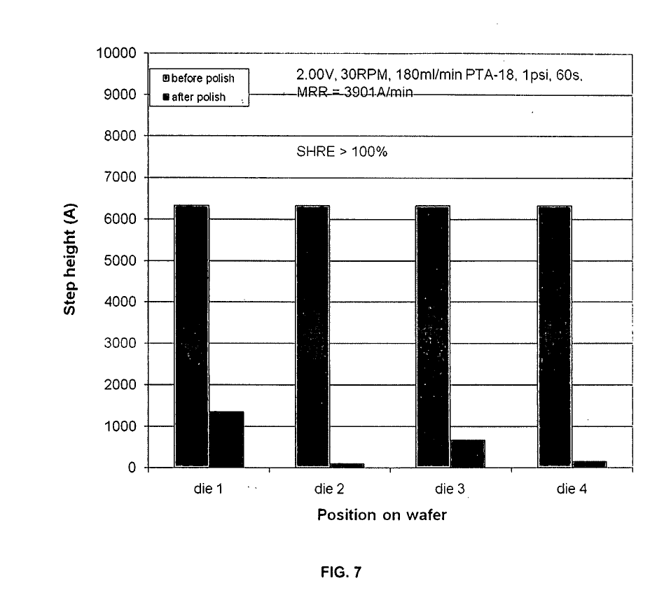

Commercially patterned copper wafers were polished in a typical ECMP type tool, using techniques and methods known to one of skill in the art. The varying compositions and conditions, as described below, were used to determine the effectiveness of two different electrolyte polishing solutions.

| | |
|---|---|
| Composition F as shown in FIG. 6: | |
| HEDP (1-hydroxyethylidene diphosphonic acid) | 6 wt % |
| Benzotriazole | 0.12 wt % |
| Ammonium Citrate Tribasic | 1.0 wt % |
| Sodium Dodecylbenzene Sulphonate | 1.2 wt % |
| Colloidal Silica | 3.0 wt % |
| Potassium Hydroxide | added to adjust pH |
| | to about 4.0 |
| Water | Balance |
| Potential Difference (wafer/electrode) | 5.00 V |
| Down force from pad | 1 psi |
| Electrolyte flow rate | 180 ml/min |
| Pad rotation (same as wafer) | 30 rpm |
| Process time | approx 40 seconds |
| Composition G as shown in FIG. 7: | |
| HEDP (1-hydroxyethylidene diphosphonic acid) | 12 wt % |
| Ammonium Citrate Tribasic | 2.0 wt % |
| Oxalic Acid | 65 mM |
| Ethylenediamine | 2.0% vol |
| 5 Phenyl 1H-tetrazole | 1 mM |
| Propanol | 1.0% vol |
| Triton X-100 | 0.16 wt % |
| Colloidal Silica | 3.0 wt % |
| Potassium Hydroxide | added to adjust pH |
| | to about 3.0 |
| Water | Balance |
| Potential Difference (wafer/electrode) | 2.00 V |
| Down force from pad | 1 psi |
| Electrolyte flow rate | 180 ml/min |
| Pad rotation (same as wafer) | 30 rpm |
| Process time | approx 60 seconds |

Before and after performing the ECMP process, a profiler tool was used to evaluate the step height of different features on the wafer, each feature being a 100*100 μm type feature. The step heights after polishing are then compared with the step heights prior to polishing of the patterned wafer, and the metal removal rates were evaluated using a typical 4-points type probe tool. This data was then used to calculate the Step Height Reduction Efficiency (“SHRE”), a well known measure of the ratio of the removal rate used to planarize the wafer features to the removal rate used to uniformly remove copper. If the SHRE is around 100% then all the material removal comes from the top of the feature and is representative of a short time to complete planarization. Likewise, if the SHRE is 0% then this represents that the copper is removed at an equal rate from the top and bottom of the features and that optimum planarization is not possible as the step height remains constant.

While embodiments of this invention have been shown and described, modifications thereof can be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. An electrolyte polishing composition for the electrochemical mechanical planarization of a semiconductor work-piece, the composition comprising:
a) between about 1% and about 20%, by weight, of a phosphonic acid based electrolyte;
b) between about 0.01% and about 1.0%, by weight, of a corrosion inhibitor;
c) between about 0.1% and about 10%, by weight, of a chelating agent;
d) between about 0.1% and about 35%, by weight, of a pH adjusting agent to provide an overall pH between about 1 and 10, and
e) a solvent as the remainder.

2. The composition of claim 1, wherein the phosphonic acid based electrolyte comprises at least one member selected from the group consisting of HEDP (1-hydroxyethylidene diphosphonic acid), MDP (methylene diphosphonic acid), VDPA (vinylidene-1,1-diphosphonic acid), SEDP (2-sulfanatoethylidene-1,1-biphosphonic acid), PBTC (phosphonobutane-tricarboxylic acid), and mixtures thereof.

3. The composition of claim 1, further comprising between about 5% and about 15%, by weight, of the phosphonic acid based electrolyte.

4. The composition of claim 1, wherein the corrosion inhibitor comprises at least one member selected from the group consisting of benzotriazole, 5-phenyl 1H-tetrazole, benzimidazol, and mixtures thereof.

5. The composition of claim 4, wherein said phosphonic acid based electrolyte is HEDP (1-hydroxyethylidene diphosphonic acid).

6. The composition of claim 1, wherein the chelating agent comprises at least one member selected from group consisting of ethylenediamine, diethylenetriamine, ammonium citrate tribasic, ammonium citrate dibasic, glycine, oxalic acid, and mixtures thereof.

7. The composition of claim 1, further comprising between about 0.5% and about 6%, by weight, of said chelating agent.

8. The composition of claim 1, wherein the pH adjusting agent comprises at least one member selected from the group consisting of potassium hydroxide, trimethylammonium hydroxide, ammonium hydroxide, and mixtures thereof.

9. The composition of claim 1, wherein the pH of the composition is between about 3 and 8.

10. The composition of claim 1, further comprising between about 0.1% and about 10%, by weight, of inert abrasive particles, wherein the inert abrasive particles comprise colloidal silica, alumina or ceria particles less than 1 micron in size.

11. The composition of claim 1, further comprising between about 0.1% and about 2%, by weight, of propanol, octyl phenol ethoxylate, or mixtures of thereof.

12. The composition of claim 1, further comprising between about 0.1% and 2%, by weight, of at least one surfactant selected from the group consisting of: sodium dodecylbenzene, sodium dodecylbenzene sulfonate, dodecyl trimethyl ammonium bromide, ammonium disulfonate, ammonium trisulfonate, and mixtures thereof.

13. A method for electrochemical mechanical polishing of a metal layer in a semiconductor manufacturing process, said method comprising:
a) providing a semiconductor work-piece, wherein said semiconductor work-piece comprises at least one conductive material layer disposed on a surface of the work-piece;
b) contacting said work-piece with a polishing solution comprising:
1) between about 1% and about 20%, by weight, of a phosphonic acid based electrolyte;
2) between about 0.01% and about 1.0%, by weight, of a corrosion inhibitor;
3) between about 0.1% and about 10%, by weight, of a chelating agent;
4) between about 0.1% and about 35%, by weight, of a pH adjusting agent to provide an overall pH between about 1 and 10, and
5) a solvent as the remainder; and
c) removing part of the conductive material layer through a electrochemical mechanical polishing step.

14. The method of claim 14, wherein the electrochemical mechanical polishing step further comprises:
a) applying an electric potential to the work-piece, wherein the electric potential is an anodic basis sufficient to dissolve at least a portion of the conductive material layer; and
b) applying a cyclical mechanical force to the work-piece, wherein the cyclical mechanical force polishes at least a portion of the conductive layer.

15. The method of claim 13, wherein the phosphonic acid based electrolyte comprises at least one member selected from the group consisting of HEDP (1-hydroxyethylidene diphosphonic acid), MDP (methylene diphosphonic acid), VDPA (vinylidene-1,1-diphosphonic acid), SEDP (2-sulfanatoethylidene-1,1-biphosphonic acid), PBTC (phosphonobutane-tricarboxylic acid) and mixtures thereof.

16. The method of claim 13, wherein the polishing solution comprises between about 5% and about 15%, by weight, of the phosphonic acid based electrolyte.

17. The method of claim 13, wherein the corrosion inhibitor comprises at least one member selected from the group consisting of benzotriazole, 5-phenyl 1H-tetrazole, benzimidazol, and mixtures thereof.

18. The method of claim 15, wherein said phosphonic acid based electrolyte comprises HEDP (1-hydroxyethylidene diphosphonic acid).

19. The method of claim 13, wherein the chelating agent comprises at least one member selected from group consisting of ethylenediamine, diethylenetriamine, ammonium citrate tribasic, ammonium citrate dibasic, glycine, oxalic acid, and mixtures thereof.

20. The method of claim 13, wherein the polishing solution comprises between about 0.5% and about 6%, by weight, of said chelating agent.

21. The method of claim 13, wherein the pH adjusting agent comprises at least one member selected from the group consisting of potassium hydroxide, trimethylammonium hydroxide, ammonium hydroxide, and mixtures thereof.

22. The method of claim 13, wherein the pH of the solution is between about 3 and 8.

23. The method of claim 13, wherein the polishing solution comprises between about 0.1% and about 10%, by weight, of inert abrasive particles, wherein the inert abrasive particles comprise colloidal silica, alumina or ceria particles less than 1 micron in size.

24. The method of claim 13, wherein the polishing solution comprises between about 0.1% and about 2%, by weight, of propanol octyl phenol ethoxylate, or mixtures of thereof.

25. The method of claim 13, wherein the polishing solution comprises between about 0.1% and 2%, by weight, of at least one surfactant selected from the group consisting of: sodium dodecylbenzene, sodium dodecylbenzene sulfonate, dodecyl trimethyl ammonium bromide, ammonium disulfonate, ammonium trisulfonate, and mixtures thereof.
